(19) United States
(12) Patent Application Publication
(10) Pub. No.: US 2026/0154018 A1
(43) Pub. Date: Jun. 4, 2026

(54) MANAGEMENT SYSTEM, AND NON-TRANSITORY MEDIUM STORING PROGRAM EXECUTABLE BY INFORMATION PROCESSING APPARATUS

(71) Applicant: BROTHER KOGYO KABUSHIKI KAISHA, Nagoya (JP)

(72) Inventor: Yu MATSUO, Yokkaichi (JP)

(21) Appl. No.: 19/395,977

(22) Filed: Nov. 20, 2025

(30) Foreign Application Priority Data
Dec. 4, 2024 (JP) 2024-211680

(51) Int. Cl. G06F 3/12; H04N 1/00

(52) U.S. Cl. CPC G06F 3/1231; G06F 3/1204; G06F 3/1254; G06F 3/126; H04N 1/00413; G06F 3/1287; H04N 2201/0094

(57) ABSTRACT

A management system includes: a management program installed on an information processing apparatus; and first and second image processing apparatuses connected to the information processing apparatus. The first image processing apparatus stores a first device setting composed of setting values, and calculates a first hash value based on the first device setting. The second image processing apparatus stores a second device setting composed of setting values, and calculates a second hash value based on the second device setting. The management program causes the information processing apparatus to transmit a specified command to each of the first and second image processing apparatuses. The first image processing apparatus, in response to receiving the specified command, returns the first hash value to the information processing apparatus. The second image processing apparatus, in response to receiving the specified command, returns the second hash value to the information processing apparatus.

### REFERENCE TO RELATED APPLICATIONS

This application claims priority from Japanese Patent Application No. 2024-211680 filed on Dec. 4, 2024. The entire content of the priority application is incorporated herein by reference.

### BACKGROUND ART

A management system in which an information processing apparatus manages a plurality of image processing apparatuses is known. In such a management system, the information processing apparatus communicates with the plurality of image processing apparatuses each as a target to be managed, and a management program in the information processing apparatus displays information obtained from each of the plurality of image processing apparatuses. For example, a print manager, which is one of the known management program, obtains job information and status information from each of printers as targets to be managed, and displays the obtained information in a list.

### SUMMARY

In such a case where an administrator wishes to confirm whether all the image processing apparatuses as the targets to be managed have the same settings, the information processing apparatus obtains setting values from each of the image processing apparatuses and displays the setting values in a list on a screen of the management program. With this, the administrator is able to search for an image processing apparatus with the setting values different from the setting values of other image processing apparatuses, via the screen. However, in a case where a large amount of information is displayed on the screen, the administrator cannot easily identify the image processing apparatus with the setting values different from the setting values of the other image processing apparatuses. Further, in such a case where the information processing apparatus obtains the setting values from all the image processing apparatuses, the load on the communication is high.

To solve the above-described problem, a management system according to an aspect of the present disclosure includes: a management program installed on an information processing apparatus; and a first image processing apparatus and a second image processing apparatus which are connected to the information processing apparatus. The first image processing apparatus is configured to: store a first device setting composed of a plurality of setting values; and calculate a first hash value based on the stored first device setting. The second image processing apparatus is configured to: store a second device setting composed of a plurality of setting values; and calculate a second hash value based on the stored second device setting. The management program causes the information processing apparatus to perform a transmitting process of transmitting a specified command to each of the first image processing apparatus and the second image processing apparatus. In response to receiving the specified command, the first image processing apparatus is configured to return the first hash value to the information processing apparatus. In response to receiving the specified command, the second image processing apparatus is configured to return the second hash value to the information processing apparatus. After the transmitting process has been performed, the management program causes the information processing apparatus to perform: an icon determining process of determining a first icon corresponding to the first image processing apparatus and a second icon corresponding to the second image processing apparatus; and an icon displaying process of causing a display of the information processing apparatus to display an icon screen including the first icon and the second icon. In the icon determining process, in a case where the first hash value received from the first image processing apparatus and the second hash value received from the second image processing apparatus are the same, the management program causes the information processing apparatus to determine the first icon and the second icon to be a same icon, and in a case where the first hash value and the second hash value are different, the management program causes the information processing apparatus to determine the first icon and the second icon to be different icons.

To solve the above-described problem, a management system according to another aspect of the present disclosure includes: a management program installed on an information processing apparatus; and a plurality of image processing apparatuses connected to the information processing apparatus. Each of the plurality of image processing apparatuses is configured to: store a device setting composed of a plurality of setting values; and calculate a hash value based on the device setting. The management program causes the information processing apparatus to perform a transmitting process of transmitting a specified command to each of the plurality of image processing apparatus. In response to receiving the specified command, each of the plurality of image processing apparatuses is configured to return the hash value to the information processing apparatus. After the transmitting process has been performed, the management program causes the information processing apparatus to perform: a determining process of determining an icon, with respect to each of the plurality of image processing apparatuses, based on the hash value received from each of the plurality of image processing apparatuses; and a displaying process of causing a display of the information processing apparatus to display an icon screen including the icon corresponding to each of the plurality of image processing apparatuses. In the determining process, in a case where any two image processing apparatuses, included in the plurality of image processing apparatuses, have the same hash value, the management program causes the information processing apparatus to associate a same icon with the two image processing apparatuses, and in a case where the two image processing apparatuses have different hash values, the management program causes the information processing apparatus to associate different icons each with a corresponding one of the two image processing apparatuses.

In each of the management systems having the above-described configuration, the management program causes the information processing apparatus to obtain the hash values each corresponding to the device setting stored in a corresponding one of the plurality of image processing apparatuses as the targets to be managed. In a case where the hash value obtained from a certain image processing apparatus and the hash value obtained from another image processing apparatus are the same, the management program causes the information processing apparatus to associate the same icon with the certain image processing apparatus and the another image processing apparatus, and in a case where the hash value obtained from the certain image processing apparatus and the hash value obtained from the another image processing apparatus are different, the management program causes the information processing apparatus to associate different icons, respectively, with the certain image processing apparatus and the another image processing apparatus, and the management program causes the information processing apparatus to display the icons each of which corresponds to one of the image processing apparatuses. With this, the differences in the device settings are displayed as the icons, enabling the administrator to easily grasp whether the setting values of the device settings are the same or different regarding the plurality of image processing apparatuses. Further, in the management system, the management program causes the information processing apparatus to obtain the hash value of the device setting, rather than the device setting per se, from each of the plurality of image processing apparatuses. Accordingly, the size of the data transmitted from each of the plurality of image processing apparatuses to the information processing apparatus is reduced as compared to a configuration wherein the device setting per se is obtained from each of the plurality of image processing apparatuses, thereby reducing the load on the communication.

A control method and a computer program for realizing the function of the above-described management system, and a computer-readable storage medium storing the computer program also contribute to solving the above-described problem.

The technique described in the present specification provides a management system which is configured to manage a plurality of image processing apparatuses, and which realizes both the improvement in the ease of identifying an image processing apparatus, among the plurality of image processing apparatuses, having the setting values different from the setting values of the other image processing apparatuses, and in the reduction in the load on communication.

### BRIEF DESCRIPTION OF DRAWINGS

FIG. 1 is a diagram illustrating the schematic configuration of an information processing apparatus having a management application according to an embodiment.

FIG. 2 is a sequence chart describing a batch setting function.

FIG. 3 is a diagram illustrating an example of a completion notifying screen.

FIG. 4 is a sequence chart describing a device setting confirming function.

FIG. 5A is a diagram illustrating an example of a management table, FIG. 5B is a diagram illustrating an example of an icon table, and FIG. 5C is a diagram illustrating an example of the management table.

FIG. 6 is a flowchart describing an example of a control procedure for an icon determining process.

FIG. 7 is a diagram illustrating an example of a confirmation screen.

FIG. 8 is a sequence chart describing an example of a control procedure for a device setting displaying process.

FIG. 9 is a diagram illustrating an example of an icon database prepared in a management application of another embodiment.

FIG. 10 is a flowchart describing an example of the control procedure for the icon determining process.

FIG. 11 is a sequence chart describing an example of a process of calculating a hash value in accordance with a confirming command.

FIG. 12 is a sequence chart describing an example of a process of generating the hash value in accordance with a hash value calculating command.

### DESCRIPTION

In the following, a program related to the present embodiment will be described in detail, with reference to the attached drawings. The present embodiment relates to a management system in which a plurality of printers is connected to a personal computer (hereinafter referred to as “PC”) and which manages the plurality of printers using a program incorporated in the PC.

### First Embodiment

### Schematic Configuration of Management System 5

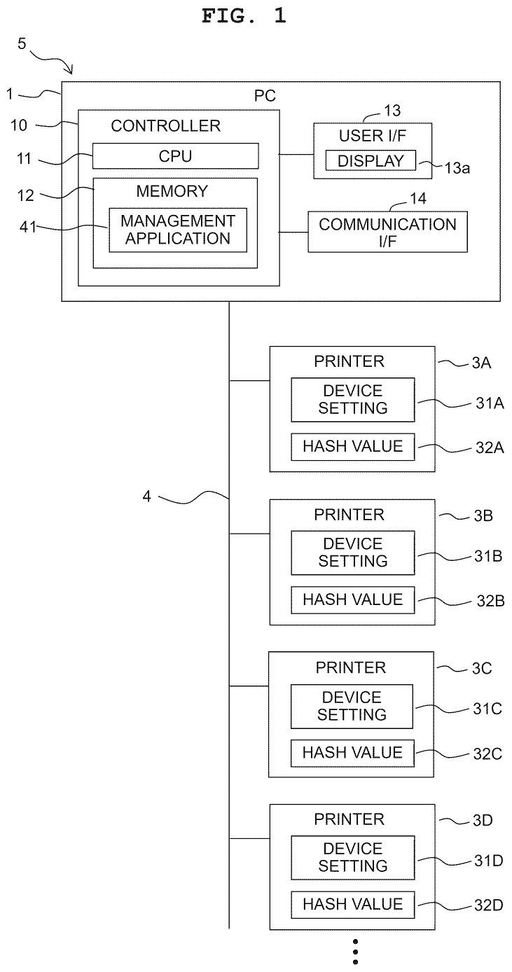

As illustrated in FIG. 1, in a management system 5 of the first embodiment, a plurality of printers 3A, 3B, 3C, 3D, etc., is connected to a PC 1 via a network 4. The PC 1 is an example of an “information processing apparatus”. The information processing apparatus is not limited to the PC, and may also be, for example, a smartphone and a tablet device. The printers 3A, 3B, 3C, 3D, etc., are examples of a “plurality of image processing apparatus”. The image processing apparatus is not limited to printers, but may also be an apparatus configured to process image, including, for example, a copying machine, a multi-function peripheral, and a scanner.

### Configuration of Printer

The printers 3A, 3B, 3C, 3D, etc., are each an apparatus having a communication function and a print function. Unless otherwise specified in the following description, the printers 3A, 3B, 3C, 3D, etc., will be collectively referred to as “printer(s) 3”. Each of the printers 3A, 3B, 3C, 3D, etc., may be a printer which performs printing on a cut sheet or a label printer which prints an image on a tape-shaped sheet to prepare labels. Each of the printers 3A, 3B, 3C, 3D, etc., may also be a multi-function peripheral which has the printing function as well as a scanning function, a copying function, a facsimile function, a mail transmitting function, etc.

The printers 3A, 3B, 3C, 3D, etc., have main memories, respectively. The main memories of the printers 3A, 3B, 3C, 3D, etc., store device settings 31A, 31B, 31C, 31D, etc., and hash values 32A, 32B, 32C, 32D, etc., respectively. Unless otherwise specified in the following description, the device settings 31A, 31B, 31C, 31D, etc., and the hash values 32A, 32B, 32C, 32D, etc., are collectively referred to as “device setting 31”, and “hash value 32”, respectively.

The device setting 31 is composed of a plurality of generic setting values which can be set for each of the plurality of printers 3. Each of the plurality of printers 3 has a function to calculate the hash value 32 based on the device setting 31 using a hash function. In a case where the plurality of printers 3 have the same hash function and where the plurality of setting values composing the device setting 31 are the same among the plurality of printers 3, the hash values 32 calculated by the hash function will be the same among the plurality of printers 3.

In such a manner, the device setting 31 is a data group which serves as the source for the hash value 32. The device setting which serves as the source for the hash value 32 includes, for example, default values for various print settings such as print orientation, double-sided printing, N-up printing (multiple pages per sheet printing), toner save, and print density. Further, the device setting which serves as the source for the hash value 32 includes setting values for various settings related to the apparatus operations, such as an on/off status of an auto sleep mode and a sleep time indicating a time when the apparatus enters an auto sleep mode.

Note that each of the printers 3 is also capable of storing setting values which are expected to differ for each of the printers 3. The setting values which are expected to differ for each of the printers 3 include, for example, setting values for communication, such as an IP address and a MAC address. The setting values which are different for each of the printers 3 are not included in the device setting 31 serving as the source of the hash value 32.

Note that each of the setting values composing the device setting 31 can be changed from an operation panel of a corresponding one of the printers 3, from an EWS (embedded web server), or from a setting command of a management application 41 to be described later. Also note that each of the printers 3 is capable of calculating and updating the hash value 32 each time the device setting 31 is changed. A function to change the device setting 31 of each of the printers 3 from the management application 41, and a function to calculate the hash value 32 will be described later.

### Configuration of PC 1

The PC 1 includes a controller 10 having a CPU 11 and a memory 12. The PC 1 includes a user interface (hereinafter referred to as “user I/F”) 13 and a communication interface (hereinafter referred to as “communication I/F”) 14 which are electrically connected to the controller 10.

The user I/F 13 includes hardware configured to display a screen to notify a user of information, and hardware configured to receive an operation by the user. The user I/F 13 may be configured such that a display function and an operation function are implemented by separate pieces of hardware, such as a display 13a and a keyboard, or by a single piece of hardware, such as a touch panel which integrates the operation function and the display function.

The communication I/F 14 includes hardware configured to communicate with an external device. The communication standard of the communication I/F 14 is, for example, Ethernet (registered trademark of FUJIFILM Business Innovation Corp.), Wi-Fi (registered trademark of Wi-Fi Alliance), and a USB. The PC 1 may include a plurality of communication I/F's 14 each supporting a corresponding one of a plurality of telecommunications standards. The method of communication may be wired communication or wireless communication.

The CPU 11 performs various processes in accordance with a program read from the memory 12, or based on an operation by the user. Note that the controller 10 illustrated in FIG. 1 is a term collectively referring to hardware and software used to control the PC 1, and does not necessarily refer to a single piece of hardware actually present in the PC 1.

The memory 12 of the PC 1 in the present embodiment stores various programs, including a management application program (hereinafter referred to as a “management application”) 41, and various data. The memory 12 is also used as a work area in a case where the various processes are performed. The management application 41 is an example of a “management program” and a “program”.

The CPU 11 may read the management application 41 from a storage medium readable by the CPU 11. For example, a CD-ROM, a DVD-ROM, and a USB memory may be used as the storage media readable by the CPU 11.

The management application 41 is a program provided by the vendor of the printer 3. The management application 41 has, for example, a batch setting function to cause the PC 1 to transmit a setting command to a plurality of printers 3 connected to the PC 1 via the communication I/F 14 of the PC 1, in batch. The setting command is a command to set setting values for a plurality of items. Each of the plurality of printers 3, which have received the setting command, updates the device setting 31 of the self in accordance with the setting command.

Further, the management application 41 has a function to select one printer 3 from the plurality of printers 3 connected to the PC 1 via the communication I/F 14, and to individually set the device setting 31 for the selected printer 3.

In the present embodiment, the management application 41 designates printers 3, among the plurality of printers 3, each of which calculates a hash value 32 using the same hash function as targets to be managed. The management application 41 has a device setting confirming function. The management application 41 obtains the hash value 32 of the device setting 31 from each of the plurality of printers 3 connected to the communication I/F 14 of the PC 1. The management application 41 associates a same first icon with certain printers 3 of which hash values 32 are the same. The management application 41 associates a second icon which is different from the first icon with another printer 3 of which hash value 32 is different from the hash value 32 of the certain printers 3. The management application 41 displays the icons each of which is associated to a corresponding one of the printers 3. The batch setting function and device setting confirming function will be described later.

### Batch Setting Function

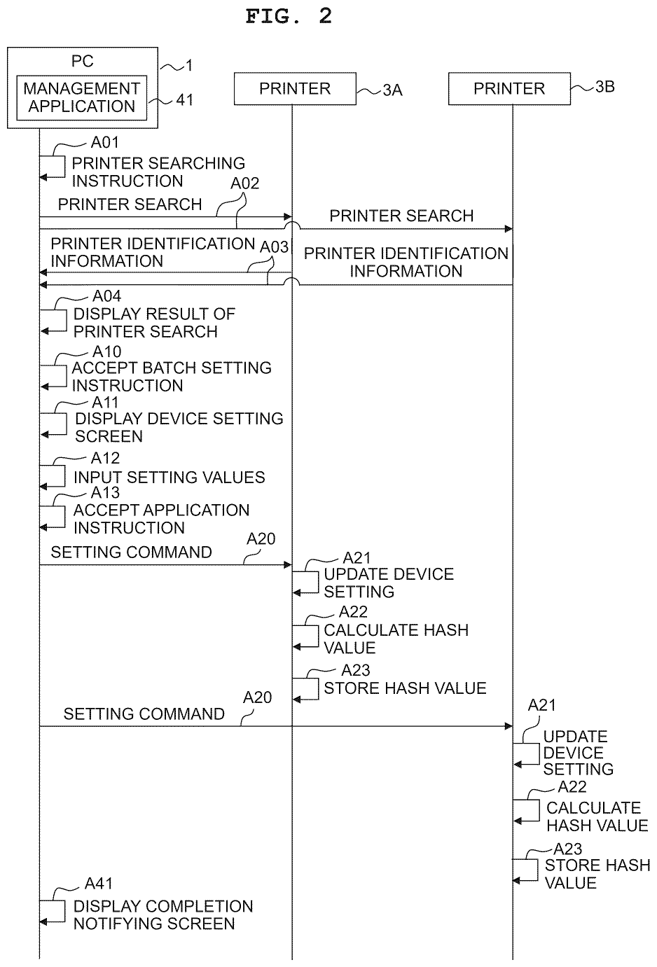

Next, the batch setting function of the management application 41 will be described with reference to FIG. 2. For example, in the PC 1, the management application 41 is started in a state where the plurality of printers 3A, 3B, 3C, 3D, etc., are connected to the PC 1 via the network 4. The management application 41, in response to receiving a printer searching instruction (step A01), performs a broadcast search using the communication I/F 14 (step A02). The management application 41 identifies a printer or printers 3 supporting the management application 41 from the devices, namely, the plurality of printers 3, found through the search. The management application 41 obtains printer identification information, such as a node name and an IP address, from the printers 3 found through the search (step A03). Note that although only two printers 3, namely, the printers 3A and 3B, are illustrated in FIG. 2, three or more printers 3 may be connected to the PC 1, and the management application 41 may obtain the printer identification information from each of the three or more printers 3.

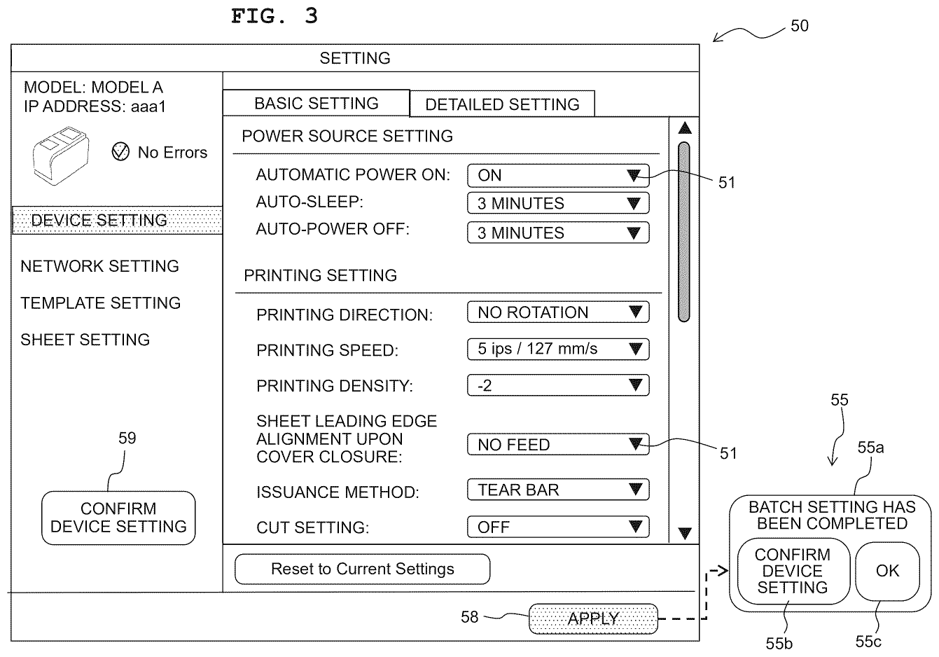

The management application 41 causes the user I/F 13 to display the result of the printer search (step A04). The management application 41 accepts the selection of a printer 3 or printers 3 each as a target of the batch setting, from among the plurality of printers 3 found by the search, and in a case where the management application 41 accepts a batch setting instruction (step A10), the management application 41 displays a device setting screen (step A11). FIG. 3 illustrates an example of the device setting screen 50. The device setting screen 50 includes input fields 51 to which setting values each for a corresponding one of batch-settable item are to be input. For example, the input fields 51 display, respectively, setting values which can be selected for each of the selected printers 3. The management application 41 accepts input of the setting values via the device setting screen 50 (step A12). In response to the apply button 58 of the device setting screen 50 being operated via the user I/F 13, the management application 41 accepts an application instruction to apply the setting values which have been input (step A13), and transmits the setting command sequentially to the selected printers 3 (step A20). The setting command includes the setting values input into the device setting screen 50.

Each of the printers 3, in response to receiving the setting command, updates the device setting 31 of the self in accordance with the received setting command (step A21). For example, in a case where the default value for the print density item in the device setting 31 is set to “0” (zero), whereas the print density item included in the setting command is set to “−2”, each of the printers 3 changes the setting value for the print density in the device setting 31 from the default value “0” to “−2”. Similarly, for example, in a case where the default value for the sleep time item included in the device setting 31 is set to “off”, whereas the “sleep time” item in the setting command is set to “3 minutes”, each of the printers 3 changes the sleep time item in the device setting 31 from the default value “off” to “on”, and further sets the sleep time to “3 minutes”.

Each of the printers 3 which has updated the device setting 31 calculates the hash value 32 from the device setting 31 (step A22) and stores the calculated hash value 32 in the main memory (step A23).

In a case where the transmission of the setting command is completed, the management application 41 causes the user I/F 13 to display a completion notifying screen 55 to notify the administrator that the batch setting has been completed (step A41). For example, in an example of the completion notifying screen 55 in FIG. 3, the completion notifying screen 55 includes a message 55a indicating that the batch setting has been completed and an OK button 55c. For example, in response to the OK button 55 being operated, the management application 41 closes the completion notifying screen 55 and returns to the device setting screen 50.

### Device Setting Confirming Function

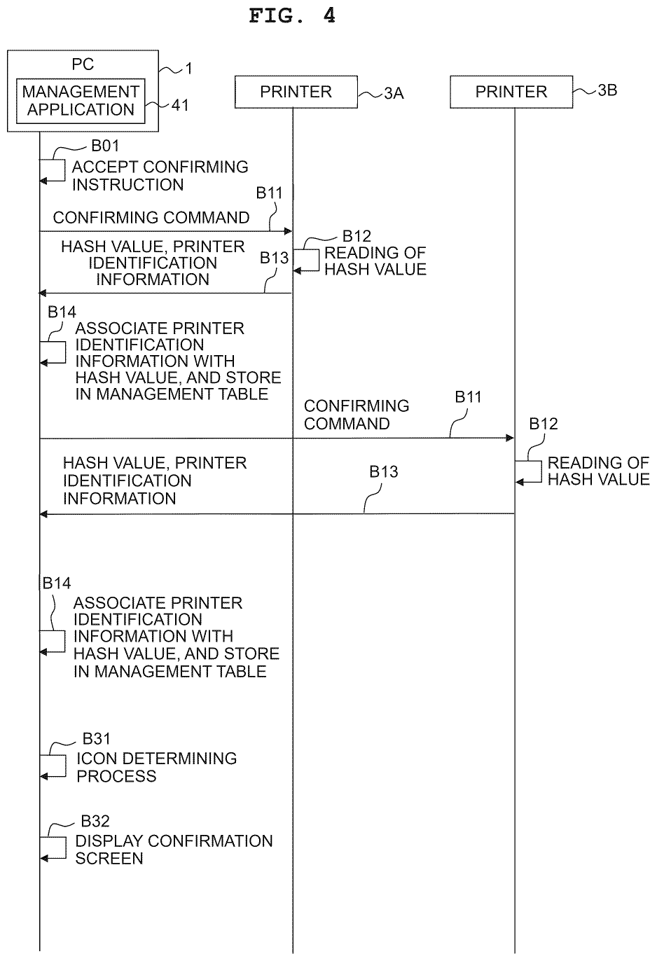

Next, the device setting confirmation function will be described, with reference to FIG. 4. In the present embodiment, a case where after the management application 41 has transmitted the setting command of the device setting to each of the printers 3 in batch, the management application 41 confirms whether the device setting is applied to all of the printers 3 each as the target to be managed will be described, as an example. In the present embodiment, a case will be described, as an example, where the printer 3B fails to receive the device setting command due to, for example, a cable disconnection in the wired connection or a communication failure in the wireless connection, due to which the setting values of the device setting 31B remain at the default values, and thus the setting values of the device setting 38B become different from the setting values of the device settings 31A, 31C, 31D, etc., respectively, of the other printers 3A, 3C, 3D, etc., each of which has received the setting command.

For example, the device setting screen 50 and the completion notifying screen 55 illustrated in FIG. 3 include, respectively, a button 59 and a button 55b. The buttons 59 and 55b are operators which accept a confirming instruction as an instruction to confirm the device setting of each of the plurality of printers 3 connected to the PC 1. In response to either the button 59 or the button 55b being operated, the management application 41 accepts the confirming instruction (step B01), as illustrated in FIG. 4, and transmits the confirming command via the broadcast communication (step B11). The confirming command is an example of a “specified command”. The process of step B11 is an example of a “transmitting process”.

Among the apparatuses connected to the PC 1, the printers 3 which calculate the hash value 32 using the same hash function are capable of supporting the confirming command from the management application 41. Each of the printers 3 which supports the confirming command reads the hash value 32 stored in the main memory before receiving the confirming command (step B12), adds the printer identification information of the self to the read hash value 32, and responds, to the PC 1, with the read hash value 32 to which the printer identification information of the self is added (step B13).

In the present embodiment, the printers 3A, 3C, 3D, etc., which have received the setting command and changed the device setting of the self in the same manner, respond to the management application 41 with, respectively, the hash values 32A, 32C, 32D, etc., which are the same. On the other hand, in the printer 3B, which has failed to receive the setting command, the device setting remains at the default values and differs from the device settings, respectively, of the other printers 3A, 3C, 3D, etc. Thus, the printer 3B responds to management application 41 with the hash value 32B which is different from the hash values 32A, 32C, 32D, etc., of the other printers 3A, 3C, 3D, etc.

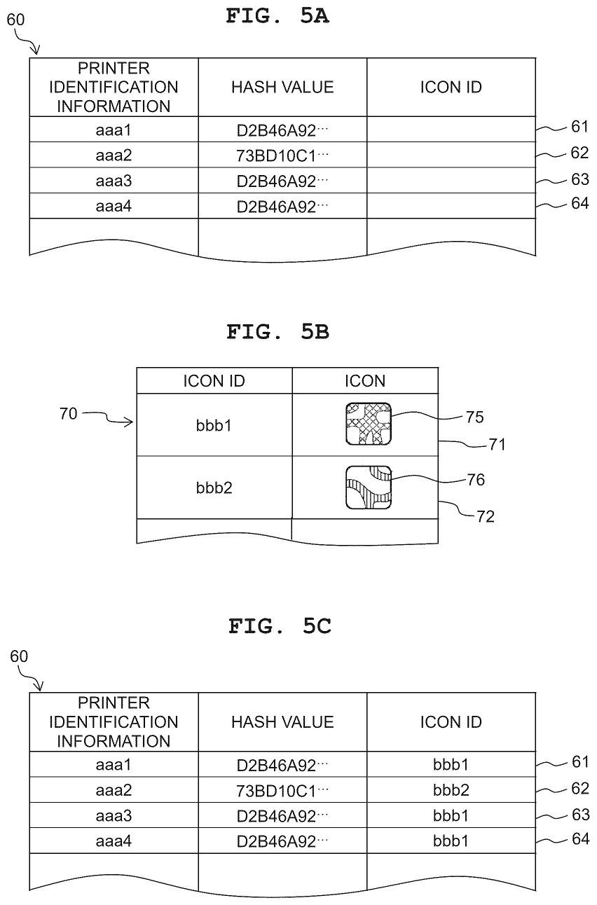

In a case where the management application 41 receives a response from each of the printers 3 via the communication I/F 14, the management application 41 associates the printer identification information and the hash value 32, which are included in the response, with each other, and stores the printer identification information and the hash value 32 in the memory, for each of the printers 3 (step B14), as illustrated in FIG. 5A. For example, the management table 60 illustrated in FIG. 5A includes a first field configured to store the printer identification information, a second field configured to store the hash information, and a third field configured to store an icon ID. The management application 41, in response to receiving a response from the printer 3A, generates a record 61, stores an IP address “aaa1” as the printer identification information for the printer 3A in the first field, and stores the hash value 32A (D2B46A92 . . . ) for the printer 3A in the second field. The printer identification information may also store a node name “printer A” of the printer 3A. The management application 41 similarly associates the printer identification information and the hash values 32B, 32C, 32D, etc., respectively, of the printers 3B, 3C, 3D, etc., with one another, and the management application 41 stores the printer identification information and the hash values 32B, 32C, 32D, etc., respectively, to records 62, 63, 64, etc. The hash value different from the hash values stored in the records 61, 63, 64, etc., for the other printers 3A, 3C, 3D, etc., is stored in the record 62 of the printer 3B which has failed to receive the setting command due to, for example, the communication failure. Note that at this stage, the third field of each of the records 61 to 64 is blank.

The management application 41, which has stored the hash values 32 for each of the printers 3 as the targets to be managed, performs an icon determining process (step B31). The icon determining process is a process to determine an icon for each of the printers 3 which have responded to the confirming command. The process in step B31 is an example of a “determining process”.

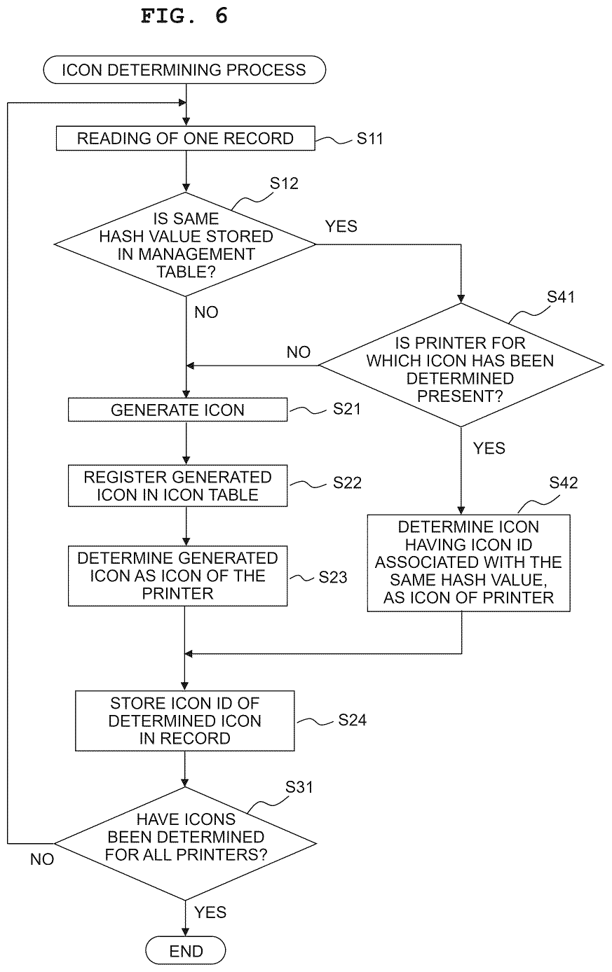

The icon determining process will be described with reference to the flowchart in FIG. 6. The CPU 11 of the PC 1 reads, for example, the record 61 from the management table 60 illustrated in FIG. 5A (step S11). The CPU 11 determines whether a hash value, which is the same as the hash value “D2B46A92 . . . ” included in the read record 61, is present in the management table 60 (step S12). Each of the hash values 32 in the management table 60 is calculated from the setting values of the device setting 31 using the same hash function. Therefore, by collating the hash values 32, the management application 41 is capable of easily determining whether the device settings match, as compared to a case of collating the device settings 31 one by one for each of the items. Further, even in a case where the items of the device setting differ among the models of the printer 3, the management application 41 is capable of using the same algorithm to determine whether the device settings match, among the printers 3, realizing high versatility.

For example, the hash value “D2B46A92 . . . ” of the printer 3A stored in the record 61 illustrated in FIG. 5A is also stored in the other records 63 and 64. In this case, the CPU 11 determines that the hash value, which is the same as the hash value “D2B46A92 . . . ” stored in the read record 61, is present in the management table 60. In a case where the hash value, which is the same as the hash value “D2B46A92 . . . ” stored in the read record 61, is present in the management table 60 (step S12: YES), the CPU 11 determines whether a printer 3 for which the icon has been already determined is present among the printers 3 of which hash values are the same as the hash value “D2B46A92 . . . ” stored in the read record 61 (step S41).

At this point, since the icon ID is not stored in each of the other records 63 and 64, the CPU 11 determines that any printer 3 for which the icon has been determined is not present among the printers 3 corresponding to the hash value “D2B46A92 . . . ” (step S41: NO), and the CPU 11 generates an icon 75 based on the hash value “D2B46A92 . . . ” (step S21). The management application 41 has a function to automatically generate icons with different aspects such as color and pattern. Since the algorithm for generating the icons is well known, the description of the algorithm will be omitted. Since the management application 41 generates the icon(s) as needed and based on the hash value 32, the management application 41 is capable of avoiding a shortage in the number of icons, as compared to a case of preparing a predetermined number of icons in advance. The process of step S21 is an example of an “icon generating process”.

The CPU 11 registers the generated icon 75 in an icon table 70 (step S22), as illustrated, for example, in FIG. 5B. FIG. 5B illustrates a state of the icon table 70 after the icon 75 and an icon 76 have been registered. In a case where the CPU 11 generates the icon 75 in step S21, the CPU 11 generates a record 71 in the icon table 70. The CPU 11 generates an icon ID “bbb1”, associates the icon ID “bbb1” with the icon 75, and stores the icon ID “bbb1” in the record 71. The CPU 11 determines the generated icon 75 to be an icon corresponding to the printer 3A (step S23).

After determining the icon corresponding to the printer 3A, the CPU 11 stores the icon ID “bbb1” of the determined icon 75 in the record 61 read in step S11, as illustrated in FIG. 5C (step S24). Note that FIG. 5C illustrates the management table 60 in which the icon IDs are stored in all the records.

After determining the icon 75 to be the icon corresponding to the printer 3A, the CPU 11 determines whether the icons have been determined for all the printers 3 as the targets to be managed (step S31). For example, in a case where the records 62, 63, 64, etc., for each of which any icon ID is not stored are present, the CPU 11 determines that the icons have not been determined for all the printers 3 as the targets to be managed (step S31: NO), and the CPU 11 returns the procedure to step S11, and reads the next record 62.

In the management table 60, no records storing a hash value same as the value “73BD10C1 . . . ” of the record 62 is present. In this case, the CPU 11 determines that the hash value, which is the same as the hash value “73BD10C1 . . . ” stored in the read record 62, is not present in the management table 60. In a case where the CPU 11 determines that the hash value, which is the same as the hash value “73BD10C1 . . . ” stored in the read record 62, is not present in the management table 60 (step S12: NO), the CPU 11 generates an icon 76, as an icon based on the hash value “73BD10C1 . . . ”, which is different from the icon 75 in the aspects such as the color and the pattern (step S21). As illustrated in FIG. 5B, CPU 11 stores the generated icon 76 in a record 72 of the icon DB70, while associating the generated icon 76 with an icon ID “bbb2” (step S22), similarly to the icon 75. The CPU 11 determines the generated icon 76 as the icon corresponding to the printer 3B (step S23), and as illustrated in FIG. 5C, the CPU 11 stores the icon ID “bbb2” associated with the icon 76 in the record 62 of the management table 60 (step S24).

Since the records 63, 64, etc., for each of which the icon ID has not been stored are present, and since the CPU 11 has not determined the icons for all the printers 3 (step S31: NO), the CPU 11 further reads the next record 63 (step S11). Since the hash value “D2B46A92 . . . ” of the read record 63 is stored in the other records 61 and 64 of the management table 60, the CPU 11 determines that the hash value, which is the same as the hash value “D2B46A92 . . . ” included in the read record 63, is present in the management table 60 (step S12: YES). Since the icon ID “bbb1” is stored in the record 61 in association with the hash value “D2B46A92 . . . ”, the CPU 11 determines that the printer 3A is present, as the printer for which the icon has already been determined, among the printers 3 corresponding to the hash value “D2B46A92 . . . ” (step S41: YES). The CPU 11 identifies the icon 75 based on the icon ID “bbb1” and determines the icon 75 as the icon corresponding to the printer 3C (step S42).

The CPU 11 stores the icon ID “bbb1” of the icon 75 in the record 63 as illustrated in FIG. 5C (step S24). The CPU 11 repeats the above-described series of processes until the CPU 11 determines the icons for all the printers 3 as the targets to be managed (step S31: NO). After determining the icons for all the printers 3 as the objects to be managed (step S31: YES), the CPU 11 ends the icon determining process.

Note that in a case where the printer 3A is an example of a “first image processing apparatus” and the printer 3B is an example of a “second image processing apparatus”, the device setting 31A is an example of “first device setting”, the hash value 32A is an example of a “first hash value”, the icon 75 is an example of a “first icon”, the device setting 31B is an example of “second device setting”, the hash value 32B is an example of a “second hash value”, and the icon 76 is an example of a “second icon”. In a case where the printer 3A is an example of the “first image processing apparatus” and the printer 3C is an example of the “second image processing apparatus”, the device setting 31A is an example of the “first device setting”, the hash value 32A is an example of the “first hash value”, the device setting 31C is an example of the “second device setting”, the hash value 32C is an example of the “second hash value”, and the icon 75 is an example of the “first icon” and “the second icon”. The icon 75 is an example of an “icon of a first aspect”, and the icon 76 is an example of an “icon of a second aspect”.

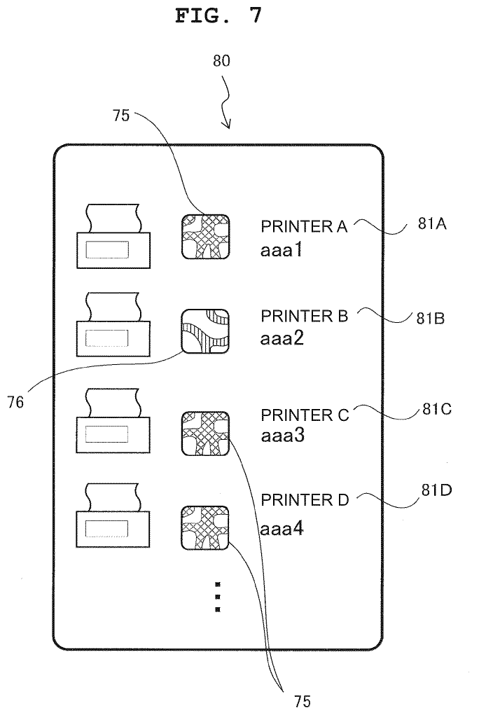

Referring to FIG. 4 again, in a case where the management application 41 has ended the icon determining process (step B31), the management application 41 causes the user I/F 13 to display a confirmation screen 80 (step B32). FIG. 7 illustrates an example of the confirmation screen 80. The management application 41 associates each of printer identification information 81A, 81B, 81C, 81D, etc., with either the icon 75 or the icon 76, for each of the printers 3A, 3B, 3C, 3D, etc., based on the management table 60, and disposes each of the printer identification information 81A, 81B, 81C, 81D, etc., in association with either the icon 75 or the icon 76 on the confirmation screen 80. Specifically, the management application 41 reads the icon 75 associated with the icon ID “bbb1” from the icon table 70 and disposes the icon 75 next to the printer identification information 81A of the printer 3A. In the present embodiment, for example, the IP address “aaa1” and the node name “printer A” of the printer 3A are displayed as the printer identification information 81A. Further, the management application 41 reads the icon 76 associated with the icon ID “bbb2” from the icon table 70 and disposes the icon 76 next to the printer identification information 81B of the printer 3B. The management application 41 similarly associates the printer identification information 81C, 81D, etc., with the icon 75 for the other printers 3C, 3D, etc., as the objects to be managed and disposes the icon 75 next to the printer identification information 81C, 81D, respectively, of the other printers 3C, 3D, etc., on the confirmation screen 80.

The administrator, upon seeing the confirmation screen 80, is capable of easily understanding that the printers 3A, 3C, and 3D, for which the same icon 75 is displayed, have the setting values of the device settings 31A, 31C, and 31D which are the same among the printers 3A, 3C and 3D, and that the printer 3B, for which the icon 76 different from the icon 75 is displayed, has the setting values of the device setting 31B which are different from the setting values of the device settings 31A, 31C, and 31D of the other printers 3A, 3C, and 3D. The confirmation screen 80 is an example of an “icon screen”. The process in step B32 is an example of an “icon displaying process” and a “displaying process”.

Although the confirmation screen 80 displays whether the device settings match in a simplified form by the icons 75 and 76, the confirmation screen 80 does not display the detailed device setting of each of the printers 3. Therefore, in response to either the icon 75 or the icon 76 displayed on the confirmation screen 80 being operated via the user I/F 13, the management application 41 causes the display 13a to display the setting values of the device setting 31 of the printer 3 corresponding to the operated icon.

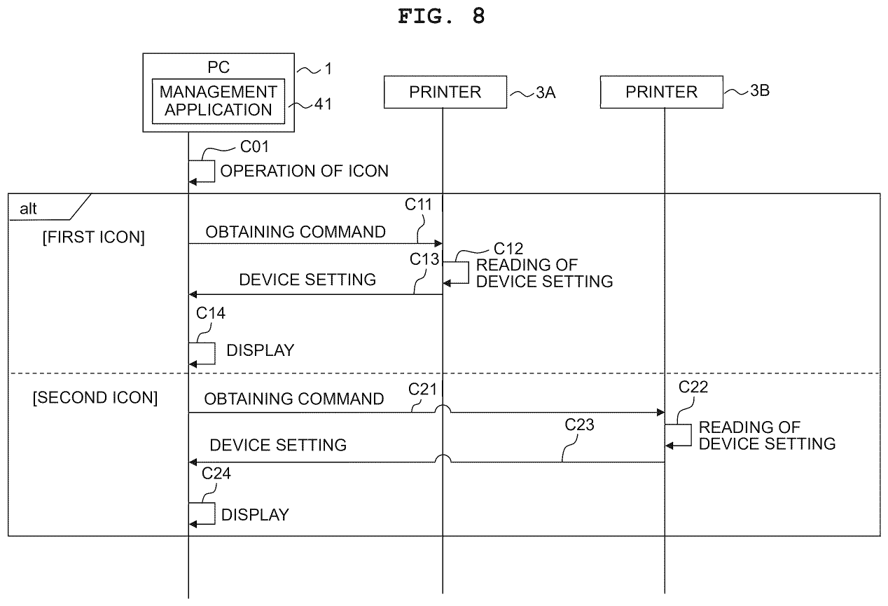

Specifically, as illustrated in FIG. 8, in a case where the icon 75 displayed next to the printer 3A is operated, via the user I/F 13, among the icons 75 and 76 on the confirmation screen 80 (step C01), the management application 41 determines that the first icon has been operated. In a case where the first icon is selected (alt: first icon), the management application 41 obtains the IP address “aaa1” of the printer 3A from the printer identification information 81A associated with the operated icon 75, and transmits an obtaining command to the printer 3A (step C11).

The printer 3A, in response to receiving the obtaining command, reads the device setting 31A from the main memory (step C12) and responds (with the device setting 31A) to the PC 1 (step C13). The management application 41 obtains the device setting 31A of the printer 3A via the communication I/F 14 and causes the display I/F 13 to display the device setting 31A of the printer 3A (step C14).

On the other hand, in response to the icon 76 displayed next to the printer 3B being operated, via the user I/F 13, among the icons 75 and 76 on the confirmation screen 80 (step C01), the management application 41 determines that the second icon has been selected. In a case where the second icon is selected (alt: second icon), the management application 41 transmits the obtaining command to the printer 3B, based on the printer identification information 81B associated with the operated icon 76 (step C21).

In a case where the printer 3B receives the obtaining command, the printer 3B reads the device setting 31B from the main memory (step C22) and responds (with the device setting 31B) to the PC 1 (step C23). The management application 41 obtains the device setting 31B of the printer 3B via the communication I/F 14 and causes the display 13a to display the device setting 31B of the printer 3B (step C24). The processes in steps C11 and C21 are examples of an “obtaining process”. The processes in steps C14 and C24 are examples of a “setting displaying process”.

Accordingly, the management application 41 is capable of confirming the detailed setting values of the device setting in response to the operation of the icon 75 or 76. The management application 41 obtains, for example, the device setting 31A (or device setting 31B) individually from the printer 3A (or the printer 3B) alone, which is one of the plurality of printers 3 as the targets to be managed. Owing to this configuration, the load on the communication in individually confirming the device setting 31 is smaller than in a case of obtaining the device setting 31 per se from each of the plurality of printers 3 as the targets to be managed.

In steps C14 and C24, the management application 41 may cause the confirmation screen 80 to display the setting values of the device settings individually obtained from the printer 3A or 3B, or the management application 41 may cause another screen different from the confirmation screen 80 to display the setting values of the device settings individually obtained from the printer 3A or 3B.

For example, the management application 41 causes the display 13a to display an individual device setting screen, different from the confirmation screen 80. In response to the icon 75 associated with the printer identification information 81A being operated, the management application 41 reflects the setting values of the device setting 31A, individually obtained from printer 3A, on the individual device setting screen. In this case, since the printer 3A is automatically selected as the target of the setting on the individual device setting screen, the time and effort to select the printer 3A is omitted.

In response to the printer selected on the individual device setting screen being switched from the printer 3A to the printer 3B, the management application 41 is capable of making the device setting 31A of the printer 3A usable as the setting for the printer 3B. In a case where the management application 41 receives an instruction to perform individual device setting in this state, the management application 41 is capable of transmitting, to the printer B, an individual setting command including the setting values which are the same as the setting values of the device setting 31A of the printer 3A. The printer 3B changes the setting values of the device setting 31B in accordance with the individual setting command. As a result, the management application 41 is capable of easily modifying the device setting 31B of the printer 3B, which has, for example, not been successfully set by the batch setting function, to match the device setting 31A of the printer 3A which has been successfully set by the batch setting function.

As described above, in the first embodiment, the management system 5 causes the PC 1 to obtain, via the management application 41 and from the printers 3A, 3B, 3C, 3D, etc., as the targets to be managed, the hash values 32A, 32B, 32C, 32D, etc., respectively, each of the hash values 32A, 32B, 32C, 32D, etc., being associated with a corresponding one of the device settings 31A, 31B, 31C, 31D, etc., and being stored in a corresponding one of the printers 3A, 3B, 3C, 3D, etc. In a case where the hash value 32 obtained from a certain printer 3 and the hash values 32 obtained from another printer 3 are the same, the PC 1 causes, with the management application 41, the confirmation screen 80 to display the same icon 75 as corresponding to the certain printer 3 and the another printer 3. In a case where the hash value 32 obtained from the certain printer 3 and the hash values 32 obtained from the another printer 3 are different, the PC 1 causes, with the management application 41, the confirmation screen 80 to display, for example, the icon 75 as corresponding to the certain printer 3 and the icon 76 different from the icon 75 as corresponding to the another printer 3. With this, the difference in the device settings 31A, 31B, 31C, 31D, etc., are displayed using the icons 75 and 76, enabling the administrator to easily determine whether the setting values of the device settings 31A, 31B, 31C, 31D, etc., are the same or different among the plurality of printers 3A, 3B, 3C, 3D, etc. Further, the management system 5 obtains the hash values 32A, 32B, 32C, 32D, etc., of the device settings 31A, 31B, 31C, 31D, etc., from the printers 3, respectively, rather than the device settings 31A, 31B, 31C, 31D, etc., per se. Accordingly, as compared to a case of obtaining the device settings per se from the printers 3, the size of the data transmitted from each of the printers 3 to the PC 1 is made small, thereby reducing the load on the communication.

Furthermore, the management application 41 according to the first embodiment is capable of generating the icons 75 and 76 which are of the aspects corresponding to the hash values “D2B46A92 . . . ” and “73BD10C1 . . . ”, respectively. Accordingly, in a case where the hash values 32 are different among the printers 3A, 3B, 3C, 3D, etc., the management application 41 is capable of assigning either the icon 75 or the icon 76, which are of the mutually different aspects, to each of the printers 3A, 3B, 3C, 3D, etc.

### Second Embodiment

Next, a management application according to the second embodiment will be described. The management application 41 of the second embodiment is configured to select an icon from a plurality of icons prepared in advance and to determine the icon corresponding to each of the printers 3. This is the difference between the second embodiment and the first embodiment in which an icon is generated based on the hash value and the icon corresponding to each of the printers is determined. In the second embodiment, the configurations and processes which are similar to the configurations and processes according to the first embodiment are designated by the same reference numerals as the reference numerals of the first embodiment, and any detailed description will be omitted, as appropriate.

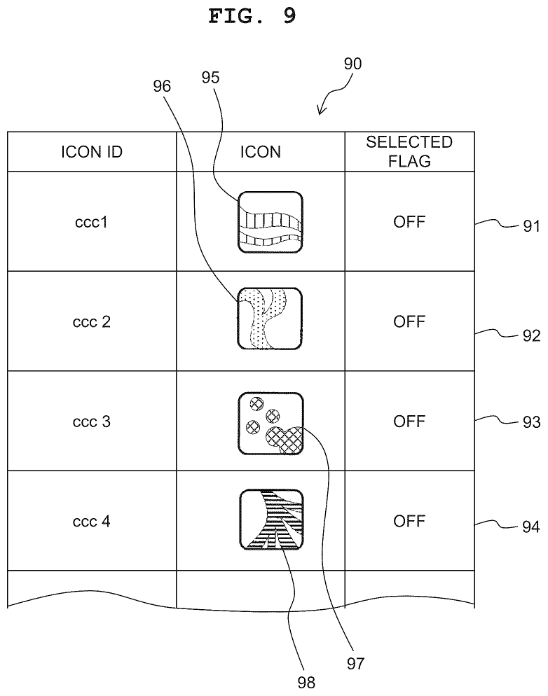

The management application 41 according to the second embodiment includes, for example, an icon database (hereinafter referred to as “icon DB”) 90 illustrated in FIG. 9. The management application 41 generates, in the icon DB 90, records 91, 92, 93, 94, etc., each for a corresponding one of icon 95, 96, 97, 98, etc., and associates each of the icon IDs with a corresponding one of the icons 95, 96, 97, 98, etc., and stores the icon IDs and the icons 95, 96, 97, 98, etc., in the records 91, 92, 93, 94, etc., respectively. The icon DB 90 stores the icons 95, 96, 97, 98, etc., which are of aspects less confusing to the administrator, i.e., the icons 95, 96, 97, 98, etc., of dissimilar appearances. Further, the management application 41 stores, in the icon DB 90, a selected flag indicating whether each of the icons is selected or not. The default value of the selected flag is “off”, indicating that the icon is not selected.

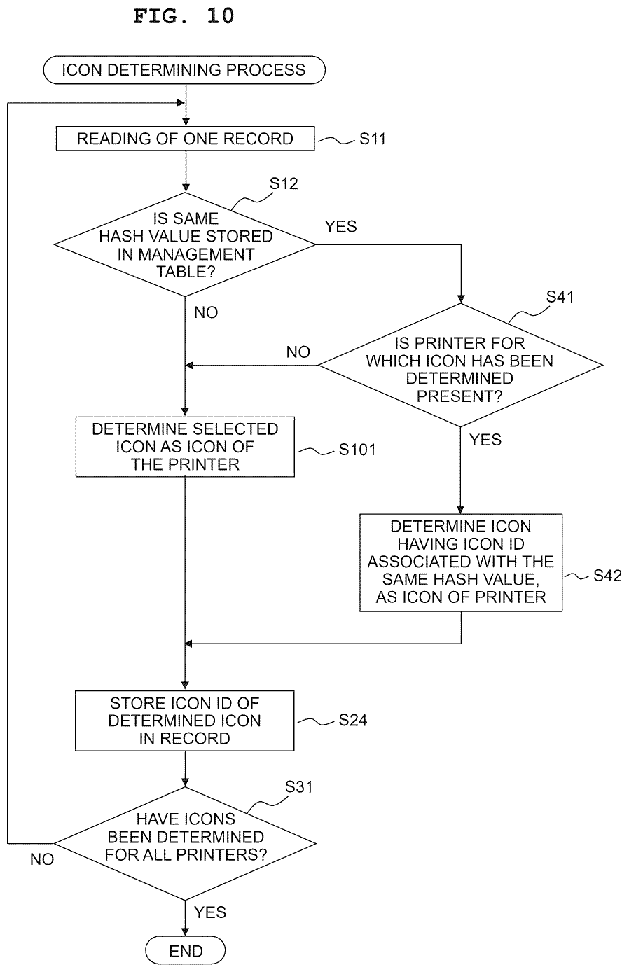

An icon determining process illustrated in FIG. 10 corresponds, for example, to the process of step B31 illustrated in FIG. 4. The CPU 11 of the PC 11 performs the icon determining process illustrated in FIG. 10, as a process performed by the management application 41. In a case where the CPU 11 determines that no hash values 32 which are the same as the hash value of another record which has been read are present in the management table 60 (step S12: NO), or in a case where a hash value 32 which is same as the hash value of another record which has been read is present in the management table 60 but a printer 3 for which the icon has been determined is not present in the management table 60 (S12: YES, S41: NO), the management program 41 selects one icon from the icons 95, 96, 97, 98, etc., in each of which the selected flag is set to “off” in the icon DB 90, and determines the selected icon to be an icon corresponding to a certain printer 3 (step S101). In a case where the CPU 11 selects, for example, the icon 95, the CPU 11 switches the selected flag of the record 91 composing the icon DB90 from “off” to “on”. This prevents the icon 95 from being associated also with another hash value 32 which is different from the hash value associated with the icon 95, in an overlapping manner. Note that the selection of the icons may be performed by the administrator or automatically by the management application 41.

On the other hand, in a case where the CPU 11 determines that the hash value 32 which is same as the hash value of another record which has been read is present in the management table 60 (step S12: YES) and where a printer 3 for which an icon (e.g., icon 96) has already been determined is present in the management table 60 (S41: YES), the CPU 11 determines the icon (e.g., icon 96) associated with the hash value 32 as the icon corresponding to the certain printer 3 (step S42).

As described above, in the management application 41 according to the second embodiment, the icons 95, 96, 97, 98, etc., of which appearances are mutually different, are prepared in advance. Accordingly, in a case where the hash values 32 are different among the printers 3, the management application 41 is capable of assigning each of the icons 95, 96, 97, 98, etc., of which appearances are mutually different to a corresponding one of the printers 3. Since the icons 95, 96, 97, 98, etc., are prepared in advance in the management application 41, a process of preparing the icons is not necessary. In a case where the icons are prepared each based on the hash value 32, an icon similar to an existing icon might be generated. Since the icons 95, 96, 97, 98, etc., are prepared in advance in the management application 41 according to the second embodiment, the likelihood of icons which are difficult to distinguish by appearance being displayed on the confirmation screen 80 can be reduced.

Note, however, an icon may be generated based on the hash value 32 each time the icon is needed, as in the management application 41 according to the first embodiment. In this case, the number of icons is less likely to be short, as compared to a case where a predetermined number of icons are prepared in advance.

The embodiments disclosed in the present specification are merely examples and do not limit the scope of the present disclosure in any way. Therefore, the techniques disclosed in the present specification may be improved or modified in various ways without departing from the scope of the invention.

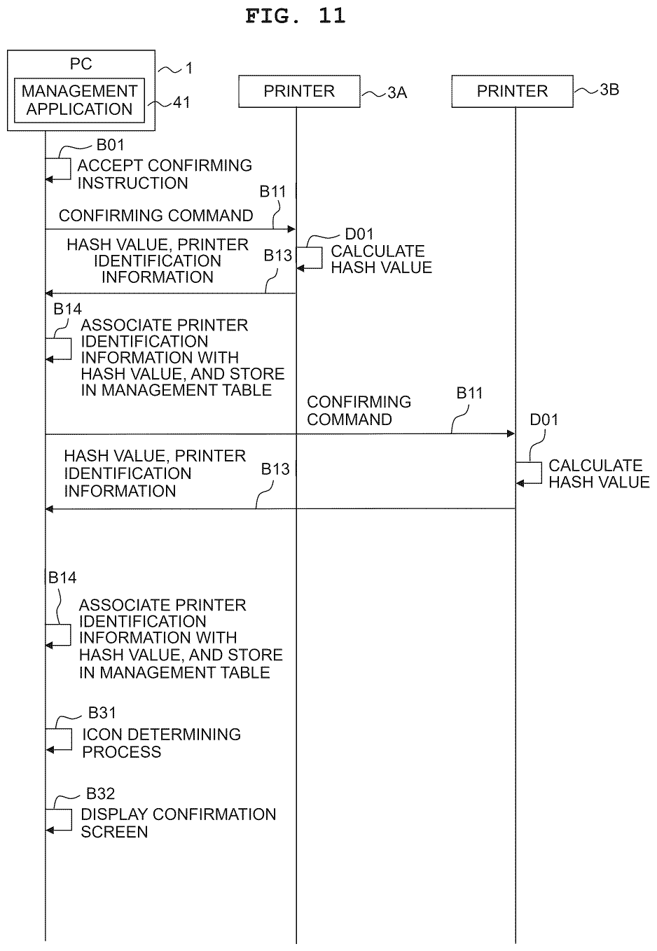

For example, as illustrated in FIG. 11, the printer 3, in response to receiving the confirming command (step B11), may calculate the hash value 32 (step D01) and may respond to the PC 1 with the calculated hash value 32 (step B13). With this, the printer 3 does not need to store the hash value 32 in the main memory, thereby reducing the load on the memory. Note, however, that as illustrated in FIG. 2, in a case where the printer 3 stores, in the main memory, the hash value calculated before receiving the confirming command, and where the printer 3, in response to receiving the confirming command, reads the stored hash value 32 and responds to the PC 1 with the hash value 32 which has been read, a faster response to the confirming command can be realized, as compared to the case of calculating the hash value after receiving the confirming command.

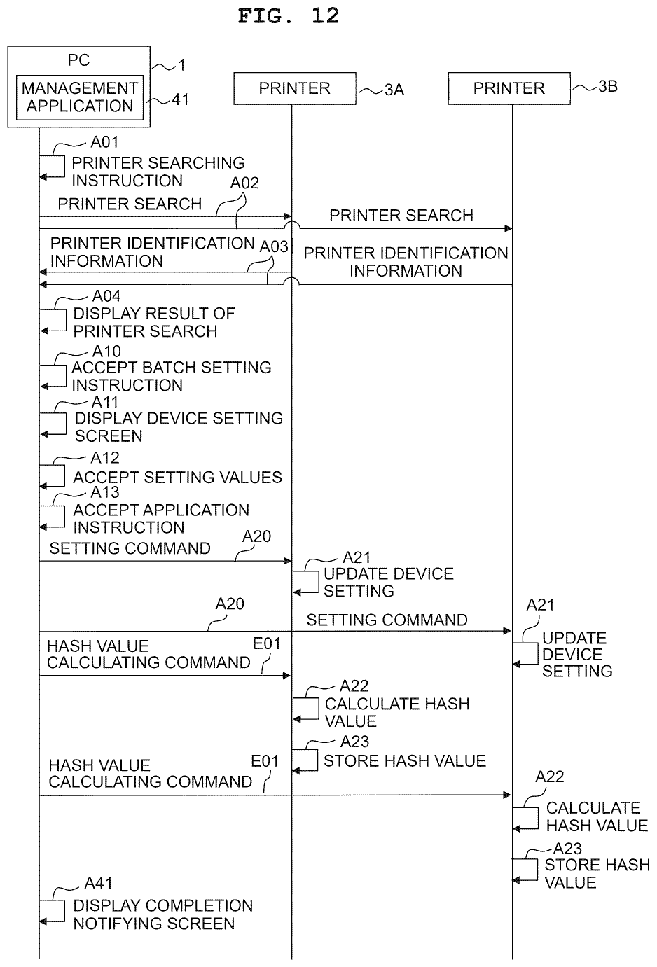

For example, as illustrated in FIG. 12, the management application 41 may transmit a hash value calculating command, which is different from the setting command and the confirming command, to a printer 3 as the target to be managed (step E01). The printer 3 may calculate the hash value 32 (step A22) and store the calculated hash value 32 in the main memory (step A23), in a case where the printer 3 receives the hash value calculating command (step E01), rather than in a case where the setting value(s) of the device setting 31 is (are) changed. Then, the printer 3, in response to receiving the confirming command (step B11), may read the stored hash value 32 from the main memory (step B12) and may respond to the PC 1 with the hash value which has been read (step B13), as illustrated in FIG. 4. For example, in a case where the management application 41 transmits the hash value calculating command after transmitting the setting command as illustrated in FIG. 12, the printer 3 is enabled, in response to receiving the confirming command, to read the hash value 32 and respond to the PC 1 with the hash value 32 which has been read. With this, the printer 3 is capable of responding faster to the confirming command, as compared to a case where the printer 3, in response to receiving the confirming command, calculates the hash value and responds to the PC 1 with the calculated hash value.

For example, the process of displaying the device settings individually for the printers, as illustrated in FIG. 8 may be omitted. Note, however, in a case that the management application 41 obtains the device setting 31 from the printer 3 corresponding to the operated icon and causes the display 13a to display the obtained device setting 31, the administrator is enabled to individually confirm the device setting 31 of the printers 3 as the targe to be managed, improving the convenience to the administrator.

The management application 41 may, for example, display the hash value confirmation screen 80 in step B32 of FIG. 4, and then may transmit, via the broadcast communication, a hash value deleting command to the printers 3 as the targets to be managed. Each of the printers 3, in response to receiving the hash value deleting command, deletes the hash value 32 from the main memory. With this, the load on the memory of the printers 3 is expected to be reduced.

Further, in each of the flow charts described in the embodiments, the order of performing the plurality of processes in any number of steps may be changed, or a plurality of processes in any number of steps may be executed in parallel, as long as no conflict arises in the contents of the processes.

Furthermore, the processes described in the embodiments may be performed by a single CPU, a plurality of CPUs, hardware such as an ASIC, or any combination of the CPU(s) and ASIC(s). Further, the processes disclosed in the embodiments may be realized in various kinds of aspects including, for example, a storage medium storing a program to perform the processes, and a method of performing the processes.

The present disclosure may include the following addendum.

### Addendum

An information processing apparatus includes: a display for displaying information; and a communication interface configured to communicate with a first image processing apparatus and a second image processing apparatus. The first image processing apparatus is configured to: store a first device setting composed of a plurality of setting values; and calculate a first hash value based on the first device setting. The second image processing apparatus is configured to: store a second device setting composed of a plurality of setting values; and calculate a second hash value based on the second device setting. The information processing apparatus performs a transmitting process of transmitting a specified command to each of the first image processing apparatus and the second image processing apparatus. In response to receiving the specified command, the first image processing apparatus is configured to return the first hash value to the information processing apparatus, and in response to receiving the specified command, the second image processing apparatus is configured to return the second hash value to the information processing apparatus. After the transmitting process has been performed, the information processing apparatus performs an icon displaying process of displaying an icon screen including a first icon and a second icon. In the icon displaying process, in a case where the first hash value received from the first image processing apparatus and the second hash value received from the second image processing are the same, the information processing apparats causes the display to display the first icon and the second icon with the same appearance, and in a case where the first hash value and the second hash value are different, the information processing apparatus causes the display to display the first icon and the second icon with different appearances.

What is claimed is

1. A management system comprising: a management program installed on an information processing apparatus; and a first image processing apparatus and a second image processing apparatus which are connected to the information processing apparatus, wherein
the first image processing apparatus is configured to:
store a first device setting composed of a plurality of setting values; and
calculate a first hash value based on the first device setting,
the second image processing apparatus is configured to:
store a second device setting composed of a plurality of setting values; and
calculate a second hash value based on the second device setting,
the management program causes the information processing apparatus to perform a transmitting process of transmitting a specified command to each of the first image processing apparatus and the second image processing apparatus,
in response to receiving the specified command, the first image processing apparatus is configured to return the first hash value to the information processing apparatus, and
in response to receiving the specified command, the second image processing apparatus is configured to return the second hash value to the information processing apparatus,
after the transmitting process has been performed, the management program causes the information processing apparatus to perform:
an icon determining process of determining a first icon corresponding to the first image processing apparatus and a second icon corresponding to the second image processing apparatus; and
an icon displaying process of causing a display of the information processing apparatus to display an icon screen including the first icon and the second icon, and
in the icon determining process, in a case where the first hash value received from the first image processing apparatus and the second hash value received from the second image processing apparatus are the same, the management program causes the information processing apparatus to determine the first icon and the second icon to be a same icon, and in a case where the first hash value and the second hash value are different, the management program causes the information processing apparatus to determine the first icon and the second icon to be different icons.

2. The management system according to claim 1, wherein
in a case where at least one of the plurality of setting values of the first device setting is changed, the first image processing apparatus is configured to calculate the first hash value and to store the first hash value, and in response to receiving the specified command, the first image processing apparatus is configured to read the first hash value and to return the first hash value to the information processing apparatus, and
in a case where at least one of the plurality of setting values of the second device setting is changed, the second image processing apparatus is configured to calculate the second hash value and to store the second hash value, and in response to receiving the specified command, the second image processing apparatus is configured to read the second hash value and to return the second hash value to the information processing apparatus.

3. The management system according to claim 1, wherein in response to receiving the specified command, the first image processing apparatus is configured to calculate the first hash value and to return the first hash value to the information processing apparatus, and
in response to receiving the specified command, the second image processing apparatus is configured to calculate the second hash value and to return the second hash value to the information processing apparatus.

4. The management system according to claim 1, wherein
the management program causes the information processing apparatus to transmit a hash value calculating command to each of the first image processing apparatus and the second image processing apparatus,
in response to receiving the hash value calculating command, the first image processing apparatus is configured to calculate the first hash value and to store the first hash value, and in response to receiving the specified command, the first image processing apparatus is configured to read the first hash value and to return the first hash value to the information processing apparatus, and
in response to receiving the hash value calculating command, the second image processing apparatus is configured to calculate the second hash value and to store the second hash value, and in response to receiving the specified command, the second image processing apparatus is configured to read the second hash value and to return the second hash value to the information processing apparatus.

5. A management system comprising: a management program installed on an information processing apparatus; and a plurality of image processing apparatuses connected to the information processing apparatus, wherein
each of the plurality of image processing apparatuses is configured to:
store a device setting composed of a plurality of setting values; and
calculate a hash value based on the device setting,
the management program causes the information processing apparatus to perform a transmitting process of transmitting a specified command to each of the plurality of image processing apparatus,
in response to receiving the specified command, each of the plurality of image processing apparatuses is configured to return the hash value to the information processing apparatus,
after the transmitting process has been performed, the management program causes the information processing apparatus to perform:
a determining process of determining an icon, with respect to each of the plurality of image processing apparatuses, based on the hash value received from each of the plurality of image processing apparatuses; and
a displaying process of causing a display of the information processing apparatus to display an icon screen including the icon corresponding to each of the plurality of image processing apparatuses, and
in the determining process, in a case where any two image processing apparatuses, included in the plurality of image processing apparatuses, have the same hash value, the management program causes the information processing apparatus to associate a same icon with the two image processing apparatuses, and in a case where the two image processing apparatuses have different hash values, the management program causes the information processing apparatus to associate different icons each with a corresponding one of the two image processing apparatuses.

6. A non-transitory medium storing a program executable by an information processing apparatus, the program causing the information processing apparatus to perform a transmitting process of transmitting a specified command to a first image processing apparatus and a second image processing apparatus which are connected to the information processing apparatus, wherein
the first image processing apparatus is configured to store a first device setting composed of a plurality of setting values and to calculate a first hash value based on the first device setting, and in response to receiving the specified command, the first image processing apparatus is configured to return the first hash value to the information processing apparatus,
the second image processing apparatus is configured to store a second device setting composed of a plurality of setting values and to calculate a second hash value based on the second device setting, and in response to receiving the specified command, the second image processing apparatus is configured to return the second hash value to the information processing apparatus,
after the transmitting process has been performed, the program causes the information processing apparatus to further perform:
an icon determining process of determining a first icon corresponding to the first image processing apparatus and a second icon corresponding to the second image processing apparatus; and
an icon displaying process of causing a display of the information processing apparatus to display an icon screen including the first icon and the second icon, and
in the icon determining process, in a case where the first hash value received from the first image processing apparatus and the second hash value received from the second image processing apparatus are the same, the program causes the information processing apparatus to determine the first icon and the second icon to be a same icon, and in a case where the first hash value and the second hash value are different, the program causes the information processing apparatus to determine the first icon and the second icon to be different icons.

7. The medium according to claim 6, wherein the program causes the information processing apparatus to generate an icon of a first aspect corresponding to the first hash value received from the first image processing apparatus, and to determine the icon of the first aspect to be the first icon in the icon determining process,
in the case where the second hash value received from the second image processing apparatus is the same as the first hash value received from the first image processing apparatus, the program causes the information processing apparatus to determine the icon of the first aspect to be the second icon in the icon determining process, and
in the case where the second hash value is different from the first hash value, the program causes the information processing apparatus to generate an icon of a second aspect corresponding to the second hash value, and to determine the icon of the second aspect to be the second icon in the icon determining process.

8. The medium according to claim 6, wherein
the information processing apparatus has an icon database in which an icon of a first aspect and an icon of a second aspect different from the first aspect are stored,
in the case where the first hash value received from the first image processing apparatus and the second hash value received from the second image processing apparatus are the same, the program causes the information processing apparatus to determine the icon of the first aspect to be the first icon and the second icon, and
in the case where the first hash value and the second hash value are different, the program causes the information processing apparatus to determine the icon of the first aspect to be the first icon, and to determine the icon of the second aspect to be the second icon.

9. The medium according to claim 6, wherein
in a case where selection of the first icon is received on the icon screen, the program causes the information processing apparatus to transmit an obtaining command to the first image processing apparatus,
in a case where selection of the second icon is received on the icon screen, the program causes the information processing apparatus to transmit the obtaining command to the second image processing apparatus,
in response to receiving the obtaining command, the first image processing apparatus is configured to return the first device setting to the information processing apparatus,
in response to receiving the obtaining command, the second image processing apparatus is configured to return the second device setting to the information processing apparatus,
in a case where the information processing apparatus receives the first device setting from the first image processing apparatus, the program further causes the display of the information processing apparatus to display the first device setting, and
in a case where the information processing apparatus receives the second device setting from the second image processing apparatus, the program further causes the display of the information processing apparatus to display the second device setting.

10. A non-transitory medium storing a program executable by an information processing apparatus, the program causing the information processing apparatus to perform a transmitting process of transmitting a specified command to each of a plurality of image processing apparatuses connected to the information processing apparatus, wherein
each of the plurality of image processing apparatuses is configured to store a device setting composed of a plurality of setting values and to calculate a hash value based on the device setting,
in response to receiving the specified command, each of the plurality of image processing apparatuses is configured to return the hash value to the information processing apparatus,
after the transmitting process has been performed, the program causes the information processing apparatus to further perform:
a determining process of determining an icon with respect to each of the plurality of image processing apparatuses, based on the hash value received from each of the plurality of image processing apparatuses; and
a displaying process of causing a display of the information processing apparatus to display an icon screen including the icon corresponding to each of the plurality of image processing apparatuses, and
in the determining process, in a case where any two image processing apparatuses, included in the plurality of image processing apparatuses, have the same hash value, the program causes the information processing apparatus to associate a same icon with the two image processing apparatuses, and in a case where the two image processing apparatuses have different hash values, the program causes the information processing apparatus to associate different icons each with a corresponding one of the two image processing apparatuses.
